(19) United States
(12) Patent Application Publication
(10) Pub. No.: US 2015/0209833 A1
(43) Pub. Date: Jul. 30, 2015

(54) Automated Conveyorized Wash System to Wash Oilfield Positive Displacement Motors and Drilling Tools

(71) Applicants: Daniel Isely, Katy, TX (US); Richard Babin, Houston, TX (US); Raymond Coselli, Houston, TX (US)

(72) Inventors: Daniel Isely, Katy, TX (US); Richard Babin, Houston, TX (US); Raymond Coselli, Houston, TX (US)

(21) Appl. No.: 14/168,186

(22) Filed: Jan. 30, 2014

(51) Int. Cl. B08B 3/02; B08B 3/04

(52) U.S. Cl. CPC B08B 3/022; B08B 3/041

(57) ABSTRACT

An automated conveyorized wash system to wash oil field positive displacement motors and drilling tools can include a conveyor track to guide a load-carrying carriage filled with drilling tool parts and/or displacement motors along a predetermined path inside the washer. A relay switch and control means can be used to begin and end the washing process. Oscillating nozzle arrays and rotating nozzles are disposed throughout a series of sprayer tube assemblies further mounted onto a framework to dispense water or aqueous cleaning solution at the tool parts and/or displacement motors as they travel inside the carriage. Heated water can be used and stored in a reservoir. Motorized pumps transfer the water through flexible hosing to the spray nozzles.

### BACKGROUND OF INVENTION

The invention relates to tools used in downhole drilling, specifically to an improved system for cleaning downhole drilling tools and motors.

Prior to each use in the field, downhole drilling tools must be inspected for any damage, especially damage normally otherwise undetectable to the naked eye. To aid in the detection of normally otherwise undetectable damage, such as hairline cracks in the tools, a fluorescent dye is used in conjunction with a UV light source to indicate where cracks exist in the tools. The dye will seep into the cracks, and upon illumination with a UV light source, the dyed cracks will fluoresce, thus showing where the crack exists. However, in order for the dye to be effective, the tools must be clean.

The cleaning of tools used in downhole drilling presents many problems. Oil, bitumen, tar and other unwanted dirt are difficult to clean, not only due to their composition, but also due to the unique geometry of the tools used. The sooner the tools are cleaned, the sooner they can be inspected for any damage in order to determine if that tool is fit for re-use out in the drilling field.

Current methods of cleaning include immersion, whereby the drilling tools are broken down into their smaller components and then the components are soaked in some sort of cleaning bath. This method would allow most areas of the tools' unique geometries to be reached with cleaning solution. The drawback to this method is the time necessary to clean the tool and the logistics of providing a sizeable bath for the components to soak.

Parts washers resembling an oversized dishwasher exist wherein a tool part is placed inside the parts washer for cleaning. Pressurized aqueous-based cleaning fluid is sprayed at the tool part until the tool is clean. However, there are disadvantages when using a parts washer. A tool part's unique geometry often requires a worker to stop the cleaning process and reposition the tool part to allow other areas of the tool to be cleaned. Also, the size of the parts washer only permits one or two parts to be cleaned at a time. These make the process more laborious and time consuming as all the tool parts cannot be cleaned simultaneously. The separation of the tool parts is also a concern. Parts that make up a particular downhole tool are not freely interchangeable with parts from another downhole tool of the same model. Therefore, it is desirable to insure that the parts that make up one downhole tool are kept together. The limited capabilities of a parts washer combined with human labor increase the risk.

Other methods involve more manual methods, such as having one or more workers clean the tools using high-pressure washer guns to bombard the tools with cleaning solutions and water. This is a lengthy process requiring intensive manual labor to break down the tools into manageable components, move the tool components into place, cleaning the exposed surfaces with a high-pressure washer. Because of the unique geometries presented by the tools components, it is necessary to turn the tool component when needed to expose additional dirty surfaces for cleaning. Because it is a slow, labor-intensive process, it not only takes a great length of time and effort, but as the day goes on, the process gets longer for each tool due to fatigue. Additionally, the quality of work declines as workers suffer from more fatigue. Also, because it is labor-intensive, this can lead to injury from working with the heavy tool pieces. This creates an inferior wash result, which in turn creates delays in production and an overall loss of productivity, which is detrimental in a very competitive oil and gas industry.

Because these and other methods of cleaning downhole tools suffer from several disadvantages, there is a need for a safer and more efficient method to clean downhole tools. Therefore, it is an object of the invention to clean downhole tools quickly through an automated process, thereby allowing the tools to be quickly put back into use in the field. Additionally, it is another object of the invention to clean tools efficiently by requiring less manual labor throughout the tool cleaning process and by capably cleaning tools with unique geometries. It is an added object of the invention to reduce the required manual labor required to move and reposition the tools. By reducing the amount of labor required to clean the tools, the danger to workers cleaning the tools is reduced and cleaning efficiency increased.

A cleaning system that is compatible with a closed-loop water system is also desired. Drilling sites do not typically have a constant water supply such as one provided by a municipality. Because it is not practical to have tanker trucks constantly removing waste water and bringing fresh water to a drilling site, closed-loop water systems are employed for recovering waste water and other fluids used in drilling. Therefore, a cleaning system operating on a drilling site must be compatible with the typical water found in a closed-loop system. Because it is an object of the cleaning system to work with a closed-loop water system, special pumps and nozzles are used that can operate with typical recovered waste water used at drilling sites.

### SUMMARY OF INVENTION

The present invention is directed to an aqueous-based cleaning system for downhole drilling tools, motors and other equipment with unique geometries.

Downhole drilling tools are disassembled and placed into a carriage. The load-carrying carriage is then engaged by an automated driven conveyor along a predetermined path wherein various hydraulic nozzles oscillate and spin, while spraying a cleaning liquid at a selected temperature and pressure toward the drilling tool parts as they pass along the conveyorized path.

Objects of this invention are explained in greater detail, of which the preferred embodiments are set forth in the following description and accompanying drawings.

### BRIEF DESCRIPTION OF DRAWINGS

FIG. 1 is a perspective view of the invention.

FIG. 2a is a perspective view of the invention with nozzle arrays in place.

FIG. 2b is a side view of the framework with the mounted nozzle arrays.

FIG. 2c is a front view of the framework with the mounted nozzle arrays.

FIG. 3a is a perspective view of the arch-like structure.

FIG. 3b is a front view of the arch-like structure.

FIG. 4 is a perspective view of an adjustable overhead tube with tube clamps.

FIG. 5 is a perspective view of a tube clamp connected to a horizontal manifold.

FIG. 6a is a perspective view of the invention with the conveyorised track.

FIG. 6b is a front view of the invention with the conveyorized track.

FIG. 7a is a perspective view of the invention with housing around the framework.

FIG. 7b is an overhead view of the invention with housing around the framework.

### DETAILED DESCRIPTION OF THE DRAWINGS

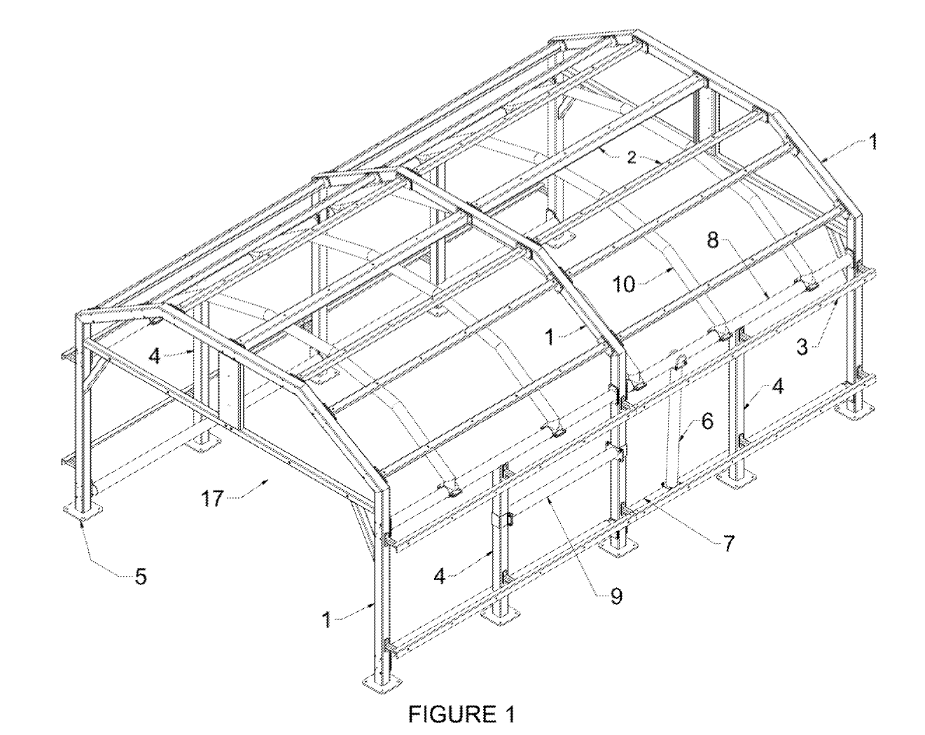

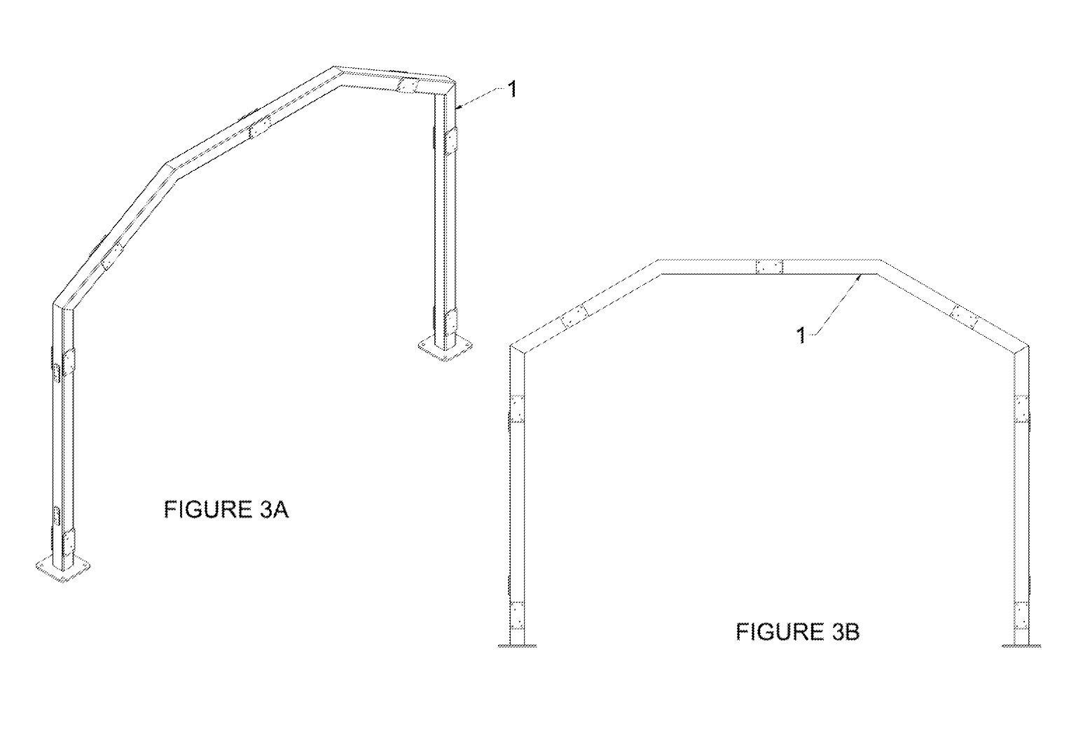

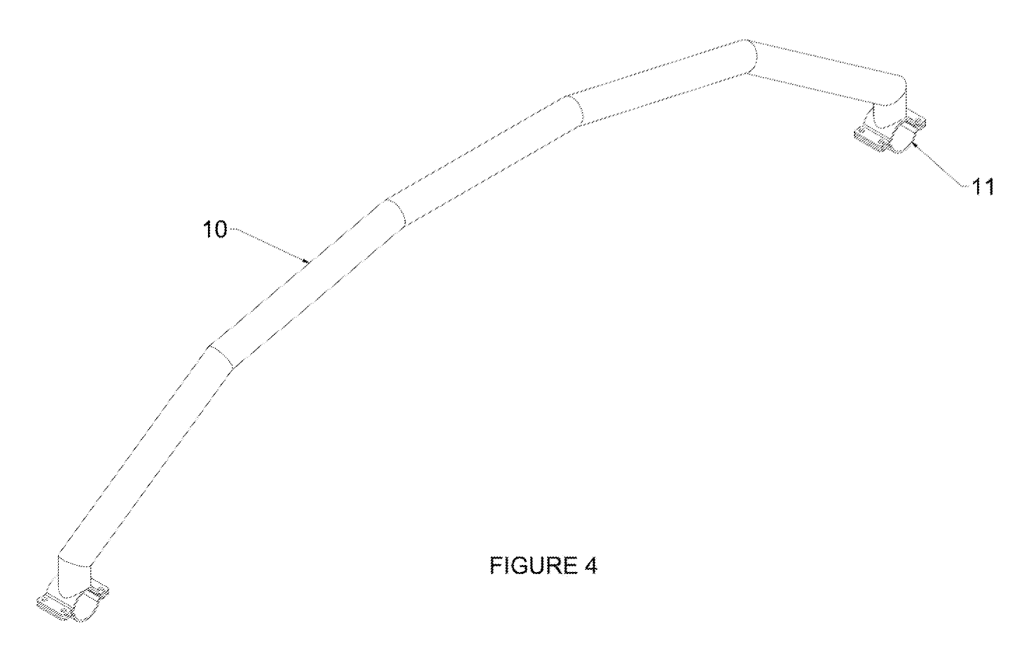

The invention is described as set forth in FIGS. 1-7. A framework whereby one or more sprayer tube assemblies are placed within the framework is shown in FIG. 1. Arch-like structures 1 are shown in detail in FIG. 3a and FIG. 3b. The framework comprises two arch-like structures 1 as shown serving as ends of the framework, with one or more arch-like structures 1 between them. A crossbar 17 can be added to the arch-like structures at each end for added support. Structure support beams 2 are provided to connect and support the arch-like structures. Side guard mountings 3 are also provided with sufficient offset to provide space between the framework and the guard. Vertical side beams 4 provide additional support to the side guard mountings and to the sprayer tube assemblies. Corrosion-resistant stainless steel or other suitable material known to be sufficient in the art is employed in constructing the framework.

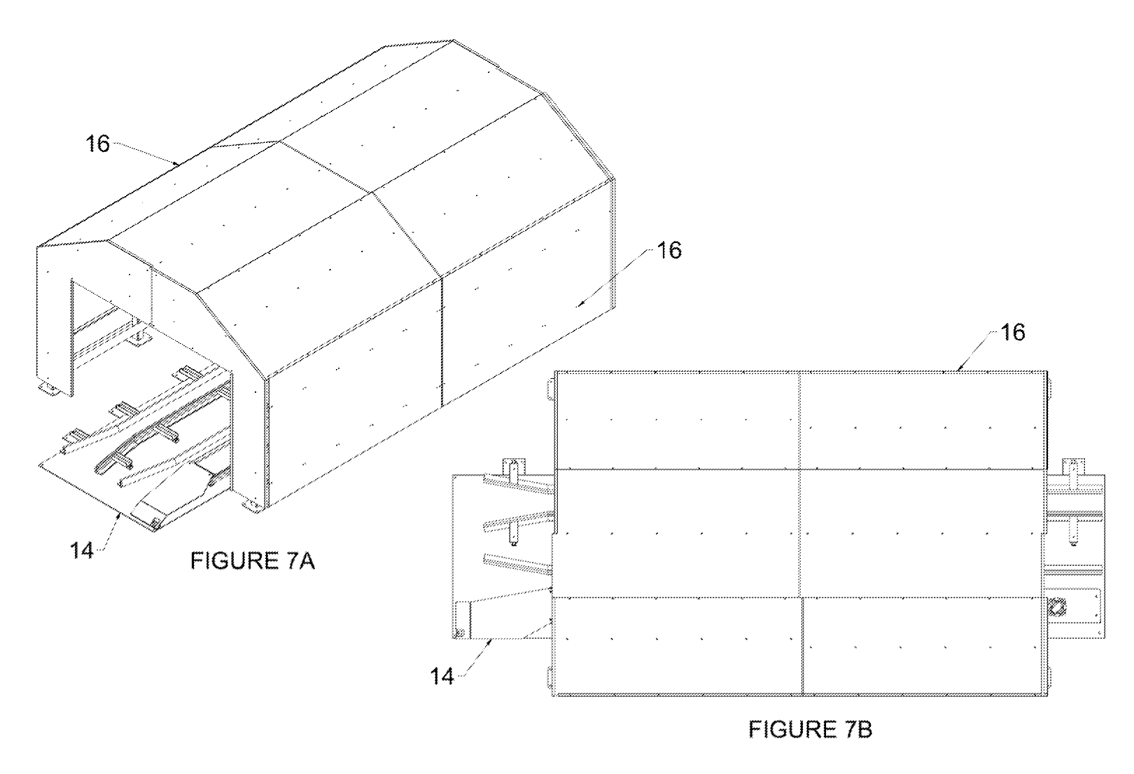

Foot pad structures 5 are disposed at the bottom of the framework that provide a flat surface to interface to a foundation. The foot pad structures can be further secured to the foundation by way of bolts, concrete fasteners or other suitable methods understood in the art. The framework can be covered by a suitable housing 16 designed to provide protection against the environment as shown in FIGS. 7a and 7b.

Horizontal sprayer tube assemblies are mounted horizontally and vertical sprayer tube assemblies 6 are mounted vertically along the sides of the framework, connected to the series of vertical support beams 4 that make up part of the framework. In FIG. 1, an upper sprayer tube assembly 8 spanning the length of the framework is disposed substantially near the ceiling of the framework, while lower sprayer tube assemblies 7 similarly spanning the length of the framework is shown closer to the floor of the framework. Additional shorter sprayer tubes 9 can be placed within a set of support beams.

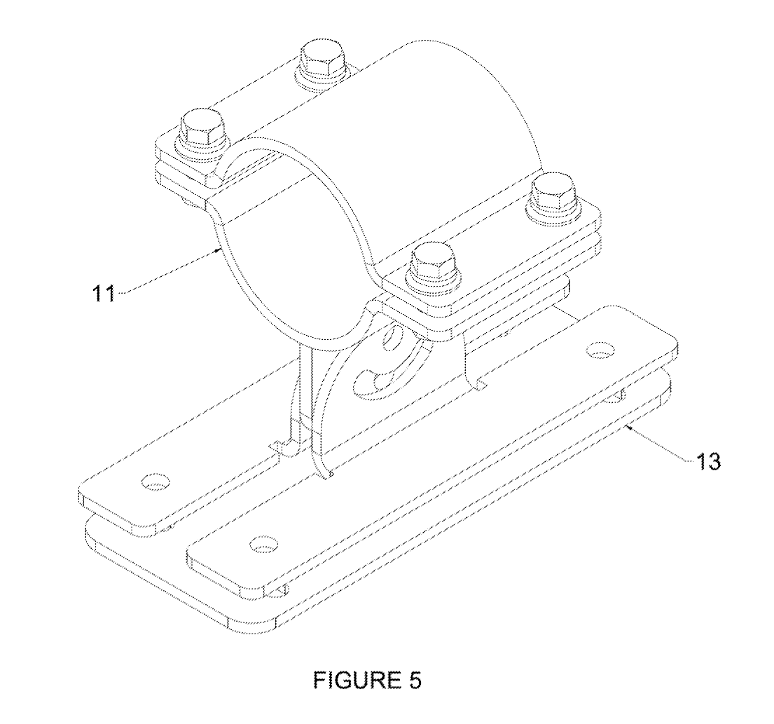

Adjustable overhead sprayer tube assemblies 10 are mounted to span the width of the framework just under the ceiling. The upper sprayer tube assemblies 8 serve as additional supports for the adjustable overhead sprayer tube assemblies. The adjustable overhead sprayer tube assemblies 10 can be joined to the upper sprayer tube assemblies 8 through saddle clamps 11 or other adjustable mounts understood in the art. The use of saddle clamps or tube clamps 11 as shown in FIG. 5 or other adjustable mounts permit the tube assemblies to be repositioned when necessary.

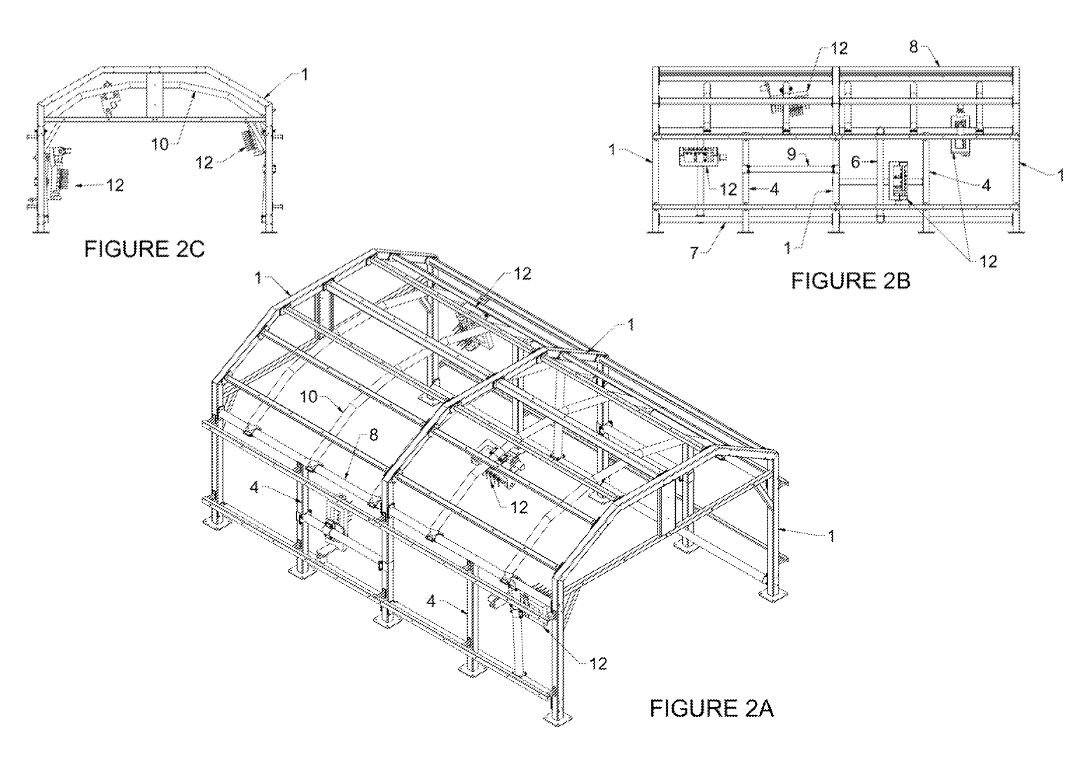

In FIGS. 2a, 2b and 2c, hydraulic nozzle assemblies 12 are dispersed along the sprayer tube assemblies. Single rotating or spinning nozzles can also be positioned along the sprayer tube assemblies. In order to effectively disperse water along the tool parts, it is desired that these nozzles can oscillate or rotate as needed. Motorized mechanisms can be employed to make the nozzles and nozzle arrays move as desired.

Oscillating hydraulic nozzle assemblies are known in the art. These nozzle assemblies oscillate in a repeated, pre-set pattern, powered by hydraulic energy, while dispensing liquid. In this manner, the aqueous cleaning solution will be dispersed over a larger area of the downhole tool part.

Oscillating hydraulic nozzle assemblies are mounted at various points on the sprayer tube assemblies. The oscillating hydraulic nozzle assemblies are directly mounted to a bracket 13 that is further connected to a tube clamp 11. The connection between the bracket and tube clamp is such that the bracket can pivot. The tube clamp can tightened by the use of bolts to secure the clamp to a desired positing along a sprayer tube, and thereby placing the oscillating hydraulic nozzle assembly at a desired position along the sprayer tube. Similarly, the degree of pivot of the bracket can be secured by tightening a bolt to maintain the bracket in a certain position. By adjusting the position of the clamp along the sprayer tube, and further adjusting the angle of pivot, a nozzle array can be directed toward a certain point. By adjustably mounting the oscillating hydraulic nozzle assemblies throughout the framework, the object of the invention to accommodate the efficient cleaning of downhole tools and parts thereof with various geometries is met.

Each oscillating hydraulic nozzle assembly has two or more nozzles suitably adapted to dispense water or other aqueous-based cleaning solutions at a substantially high pressure. The current embodiment contemplates nozzles capable of delivering 160 gallons per minute at 1000 pounds per square inch of pressure. The nozzles can be arranged in a row or other pattern, with all nozzles pointing in the same direction. In operation, the nozzle assembly oscillates along a single axis. The liquid being dispensed is also used to operate the oscillation of the nozzle assembly.

Spinning hydraulic nozzles can also be disposed along the overhead tube assemblies, to provide additional cleaning The spinning hydraulic nozzles would be directed such that their spray is toward a passing carriage filled with tool parts to be cleaned.

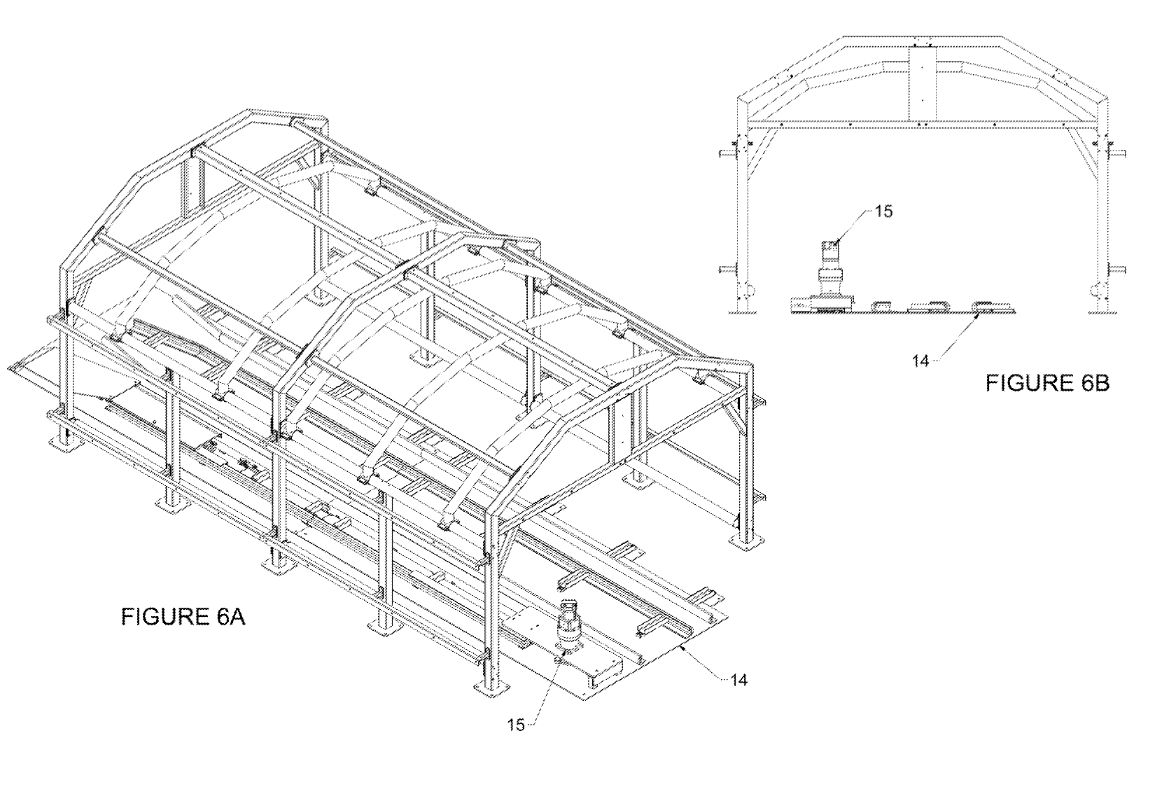

A surface-mounted conveyorized pathway 14 as shown in FIGS. 6a and 6b is implemented to guide a load-carrying carriage along a predetermined path. Automated conveyor mechanisms are readily available and can be adapted to fit accordingly.

The load-carrying carriage is provided that is suitably adapted to bear the load of tool parts. The carriage is also designed to permit a high-pressure nozzle spray to be directed at the downhole drilling tool parts. The carriage can be made of steel or other durable metal constructed in an open, cage-like design to permit high pressure nozzle spray to adequately clean the downhole drilling tool parts.

The load-carrying carriage is also designed and built with wheels so that it can readily be moved with or without a load. The load-carrying carriage is also designed and built to interface with an automated conveyor mechanism so that it can be moved along a pre-determined conveyorized pathway. In use, the load-carrying carriage can be freely moved to facilitate loading and then brought into place with the conveyor mechanism whereby it engages to conveyor mechanism thereby allowing the load-carrying carriage to be moved in an automated manner through the washing process. Load-carrying carriages of this sort are known in the art and it is the intention of the applicants that such load-carrying carriages provided by various manufacturers be interoperably compatible with the automated conveyor mechanism

The automated conveyor mechanism as engages the load-carrying carriage automatically upon placement of the load-carrying carriage in a designated position using one of several means available in the art, such as via a conveyor roller or dolly. A surface-mountable controllable drive motor 15 as shown in FIG. 6b sufficiently capable of driving the conveyor forward or backward with one or more load-carrying carriages engaged is provided. As the load-carrying carriage moves through the pre-determined conveyorized path, the carriage can trigger switches to affect a relay circuit to engage the various hydraulic nozzles placed throughout the washer, thereby engaging the washing process. The process can be timed accordingly to the rate that the load-carrying carriage travels so that certain hydraulic nozzles are engaged when the carriage is properly placed, and disengaged when the carriage is no longer within range of the nozzle spray, thereby conserving water and aqueous cleaning solutions.

Pressured delivery of water or other aqueous cleaning solution is delivered through a flexible hosing. Steel tubing can also be used. Motorized pumps capable of delivering liquid are employed to transfer fluid from a fluid reservoir through the hosing or tubing and to the various nozzles at a desired pressure. If desired, liquid heaters can be employed with the reservoirs to provide heated water or aqueous solution.

In practice, the method of using the invention involves the disassembly of a tool part to fit onto a carriage.

The load-carrying carriage is then moved to the beginning of the conveyorized pathway 14 where a conveyor wheel or dolly engages the cart, moving it into the cleaning apparatus and engaging a trip switch to engage a relay circuit, thereby beginning the cleaning cycle.

Water or aqueous cleaning solution is dispensed at a desired temperature and pressure from a reservoir through the use of motorized pumps and flexible hosing to the oscillating nozzle arrays 12 and spinning nozzles.

As the load-carrying carriage passes along the predetermined path, the oscillating nozzle arrays and spinning nozzles clean the tool parts with water or aqueous cleaning solution. The movement of the nozzles insures that the tools are cleaned thoroughly.

After the tool parts have been cleaned, they are ready to be inspected for damage prior to being sent back out into the oilfield.

The present invention has been described in terms of specific embodiments incorporating details to facilitate the understanding of principles of construction and operation of the invention. It will be readily apparent to one skilled in the art that other various modifications may be made in the chosen embodiment without departing from the spirit and scope of the invention as defined by the claims.

What is claimed is:

1. A tool washing apparatus comprising:
a supportive framework means, said framework means further comprising:
one or more sprayer tube assemblies securely mounted to said framework;
one or more overhead sprayer tube assemblies disposed transversely under the ceiling and along the length of said framework;
one or more adjustable mounts disposed along the length of each sprayer tube assembly, said adjustable mounts able to be positioned along any portion of the length of said sprayer tube assembly;
one or more nozzle assemblies, said nozzle assemblies attached to an adjustable mount such that the nozzle array may be directionally oriented in desired direction;
a means for moving said nozzle assemblies in an oscillating pattern;
one or more rotating spray nozzles attached to an adjustable mount;
a means for moving said spray nozzle in an rotating motion;
one or more fluid reservoirs;
one or more motorized pumps for delivering fluid from the fluid reservoirs to the spray nozzles at a selected pressure;
a flexible hose connecting a fluid reservoir to a motorized pump;
one or more flexible hoses for conveying fluid from a motorized pump to one or more of the spray nozzles;

2. The tool washing apparatus of claim 1 further comprising a relay means for operably activating and deactivating a group of spray nozzles based on the position of a carriage inside the tool washing apparatus.

3. The tool washing apparatus of claim 1 wherein the means for moving said spray nozzles and spray nozzle arrays are hydraulic means.

4. The tool washing apparatus of claim 1 where a heating means is employed to heat and maintain the water in the reservoir to a desired temperature.

5. An automated, converyorized tool washing system comprising:
a system housing;
a supportive framework means within said housing, said framework means further comprising:
one or more sprayer tube assemblies securely mounted to said framework;
one or more overhead sprayer tube assemblies disposed transversely under the ceiling and along the length of said framework;
one or more adjustable mounts disposed along the length of each sprayer tube assembly, said adjustable mounts able to be positioned along any portion of the length of said sprayer tube assembly;
one or more nozzle assemblies, said nozzle assemblies attached to an adjustable mount such that the nozzle array may be directionally oriented in desired direction;
a means for moving said nozzle assemblies in an oscillating pattern;
one or more rotating spray nozzles attached to an adjustable mount;
a means for moving said spray nozzle in an rotating motion;
one or more fluid reservoirs;
one or more motorized pumps for delivering fluid from the fluid reservoirs to the spray nozzles at a selected pressure;
a flexible hose connecting a fluid reservoir to a motorized pump;
one or more flexible hoses for conveying fluid from a motorized pump to one or more of the spray nozzles;
an automated conveyor track running the length of the system housing, further comprising a means for mounting and pulling a carriage along a pre-determined path;
one or more means of activating one or more nozzles or nozzle assemblies located along said conveyor track;
a carriage capable of securely holding one or more downhole tool parts, wherein said carriage can be movably mounted on said automated conveyor track such that it is moved along said automated conveyor track while pressurized fluid from one or more nozzles is directed at the tools securely held on said carriage as it moves along the automated conveyor track; and
a control means to operate the tool washing system.

6. The automated, converyorized tool washing system of claim 5 wherein said control means is by way of computer.

7. A method of washing tools with an an automated, converyorized tool washing system comprising the steps of:
engaging a carriage containing downhole tool parts onto an automated conveyorized track;
said conveyorized track moving said carriage along a pre-determined path;
one or more rotating spray nozzles and oscillating spray nozzle arrays dispensing liquid at a high temperature and high pressure toward the downhole tool parts located on said carriage as said carriage moves along the pre-determined path thereby cleaning said tool parts.
